(19) United States
(12) Patent Application Publication
(10) Pub. No.: US 2016/0334189 A1
(43) Pub. Date: Nov. 17, 2016

(54) WEIGHT SUPPORT DEVICE FOR USE WITH FIREARMS AND OTHER ELONGATE OBJECTS

(71) Applicant: Foster Steele, Visalia, CA (US)

(72) Inventor: Foster Steele, Visalia, CA (US)

(21) Appl. No.: 15/153,649

(22) Filed: May 12, 2016

Related U.S. Application Data
(60) Provisional application No. 62/159,964, filed on May 12, 2015.
(60) Provisional application No. 62/163,377, filed on May 19, 2015.
(60) Provisional application No. 62/186,377, filed on Jun. 30, 2015.

(51) Int. Cl. F41C 33/00; F16M 13/04

(52) U.S. Cl. CPC F41C 33/001; F16M 13/04; F16M 2200/06

(57) ABSTRACT

The present invention provides weight support devices for a person supporting an elongate object at a generally horizontal pitch. Specific uses of the invention include use as a shooting support stick for firearms. The present invention is not limited to firearms and may be used to support a person's arm when using various other elongate devices, such as telescopes, bow and arrow, cross-bows, etc.

### FIELD OF THE INVENTION

The present invention relates to support devices for use with firearms, crossbows, and other elongate items and/or devices that need to be held out from the body at a generally horizontal pitch. For example, the present invention may be used to support one's arm when aiming a rifle or other firearm to prevent shaking and fatigue due to the weight of the firearm.

### BACKGROUND OF THE INVENTION

The ability to keep a firearm still at the time of firing is essential to accurately firing the weapon. When holding a firearm up and taking aim, the shooter's arm may waiver under the weight of the firearm. Wind and other elements can also affect a shooter's aim. Even a slight amount of movement or flexure by the shooter can greatly affect shooting accuracy. A shot taken by the shooter may be off target due to movement that results from fatigue in the shooter's arm. Fatigue is one factor that is accentuated in the case of heavier firearms and other weapons, such as rifles, muzzle-loading firearms, crossbows, etc. Therefore, there is a need to provide a rest for supporting a firearm while shooting to increase accuracy by reducing the effects of fatigue while aiming.

Traditional shooting sticks are designed to rest on the ground to provide stable support to the firearm, the forestock of which rests in the cradle of the shooting stick.

Such traditional shooting sticks typically include telescoping leg(s) for adjusting the height of the shooting stick. However, the shooter may not be able to stabilize the base of the extensible or telescoping leg(s) against the immediately available surfaces. For example, the shooter may not have a convenient and stable surface to support the base of the shooting stick: the ground or terrain may be uneven and/or unstable and may be unsuitable for supporting the shooting stick and firearm. Thus, such traditional shooting sticks are limited in their utility, and a shooter may not be able to effectively deploy the shooting stick in many situations.

Due to such limitations in traditional shooting sticks, improved designs are needed.

### SUMMARY OF THE INVENTION

The present invention provides a portable rest for supporting firearms, shooting bows, and other elongate objects. The invention can be used by an individual to support any one of a variety of guns, such as rifles, shotguns and pistols, or other objects that the person must hold out away from the body (e.g. a telescope) in a comfortable position, and which can be easily transported and quickly deployed by the individual during use, such as in remote hunting areas.

The invention is directed to a support apparatus comprising a weight-bearing end such as a foot structure or ball that acts as anchoring member that may be placed in a pouch, pocket, or against one's body to disburse weight, a shaft member of a predetermined length (which may be adjustable for use by people of differing heights), an elbow structure at the distal end of the shaft member, and a cradle in which the user's hand, wrist, or forearm may rest during use. In some embodiments, and without limitation, the shooting stick may also include an additional cradle located near the shoulder of the user that may be used to support the user's upper arm or the proximal portion of a firearm or other device that the user is supporting with the shooting stick.

The invention may further include a specialized shoulder belt that may include a pouch or pocket into which the anchoring member may be inserted, allowing the weight of the support apparatus to be distributed to the user's shoulder through the shoulder belt. The shoulder belt may be a single strap belt that sits over one shoulder, or it may be a bilateral chest and shoulder belt design having straps that fit over both shoulders, as well as other designs. In some embodiments, the invention may further include a pocket for receiving the anchoring member that may be connected to the user's waist. For example, and without limitation, the pocket may having one or more belt loops thereon through which a belt may pass (the belt may sit around the user's waist). In another example, and without limitation, the pocket may have clips thereon to that may be fastened to a belt on the user's waist or the user's pants. It is contemplated within the present invention that the pocket may include other means of attaching to the user's waist.

In some embodiments, and without limitation, the upper portion of the shooting stick (e.g., embodiments in which the shooting stick includes an additional cradle to support the user's upper arm or the butt of the gun) may have an attachment means for connecting to a shoulder belt. The attachment of the upper portion of the shooting stick to a shoulder belt may allow the user to steady the firearm or other tool supported by the shooting stick with one hand.

The present invention also includes embodiments of a support apparatus that supports the weight of the users arm and the firearm, tool or other item that the user may be holding with a platform that includes at least one cradle thereon for receiving a portion of the user's arm. In such embodiments, and without limitation, the support structure includes a vertical support member (e.g., a shaft) that may sit against or near the torso of the user. The vertical support member may include an anchoring member on the inferior end thereof, which can be placed in a pocket or pouch positioned near the waist of the user. The platform may be attached to the vertical support member at the top of the vertical support member by a static, detachable, or hinged connection. The vertical support member may have a length that positions the platform just under the axilla or upper portion of the user's humerus when the user's arm is extended. The platform may be positioned on the vertical support member at an angle that allows the user to rest his arm and aim a firearm or other device (e.g., a rifle, bow and arrow, cross-bow, a telescope, etc.) comfortably and supports the weight of the arm and the weapon or other device such that the user's arm does not fatigue or shake. In some embodiments, and without limitation, the connection between the platform and the vertical support member may be hinged and collapsible and the support apparatus may include a positioning arm or propping rod that (1) holds the platform in position during use, and (2) can be disengaged during non-use so that the support apparatus can be collapsed. In other implementations, and without limitation, the support apparatus may have a collapsible elbow joint that supports the platform. The collapsible elbow joint may allow the platform to be positioned at various heights. In the collapsed configuration, the support apparatus can be carried on the shoulder belt for easy access.

In some implementations and without limitation, the vertical support member of the support apparatus may have an adjustable height by its insertion into one of a plurality of pockets in an apron worn on or near the waist of the user. The apron may have multiple pockets at different vertical locations on the apron, such that the anchoring member of the vertical support member can be placed at different vertical positions by virtue of the pocket into which it is inserted. The adjustability of the vertical position of the vertical support member may allow the user to accommodate for his height and build, and optimize the comfortable use of the support apparatus. In other implementations, and without limitation, the vertical support member may have an adjustable length for accommodating the height and build of the user and to optionally allow the user to extend the vertical support member for positioning on the ground. In such implementations, the support member may be supported by a pocket at or near the user's waist (e.g., a belt adapter) or by the ground. It is to be understood that the height of the apron or pockets can also be adjusted by varying the length of the shoulder belt to the user's preference (e.g., the shoulder belt may have an adjustable length to allow the pocket or apron to be placed at different heights).

The present invention also includes embodiments in which the support apparatus includes a cradle that may be attachable to the user's arm (e.g., the upper arm or forearm) and the support shaft may be hingedly attached to the cradle such that it can be stowed against (e.g., parallel to the surface of) the cradle during periods of non-use and deployed by swinging the support shaft from the stowed position to a position in which the anchoring member (located at the distal end of the shaft member) may be inserted into a pocket or pouch positioned near the waist of the user. The cradle may be attached to the vertical support member at the top of the vertical support member by a hinged connection that allows the support shaft to pivot through up to a 180° range of angles (e.g., the shaft can be positioned against the cradle when rotated in either direction allowed by the hinged joint). The support apparatus may include a receiving structure for the support shaft to hold the support shaft in place when it is placed against the cradle in the stowed position. The receiving structure may be a clip, a magnet, a trough, closable compartment, or other structure for holding the support shaft in the stowed position. In the stowed position, the support shaft may be positioned behind the arm of the user, and may thus be out of the way of the user and present not obstruction or restriction of the user's movement. The vertical support member may have a fixed length or may be extendible and collapsible (e.g., a telescoping rod, a folding rod with one or more joints therein, or other design). The cradle may be attached to the user's arm by one or more adjustable attachment members that allow the user to adjust the tightness of the one or more attachment members for a tight fit. The one or more adjustable attachment members may be belts, laces, or straps, or an adjustable cuff that wraps around the user's arm. In such embodiments, the support shaft can be quickly stowed and deployed, allowing for convenient and efficient use of the support apparatus. The user can swing the support shaft up against the cradle into the stowed position in one motion. Likewise, the user can grasp the support shaft when in the stowed position and pull it down to the desired angle relative to the cradle and place the anchoring member in into a pocket or pouch positioned near the waist of the user to support the user's arm.

Several embodiments are discussed below, but the examples embodiments shall not to be interpreted as an exhaustive list. One with ordinary skill in the art will recognize that the scope of the present invention includes further variations and equivalents to the specific examples described herein.

In one embodiment, the present invention relates to a weight support system, comprising that includes an anchoring member for resting against a user's body in the area of the waist; a support member including a platform and a cradle for supporting a portion of the user's arm or an object held by the user; and a support shaft extending from the anchoring member to the support member, wherein an angle between the plane of the platform and the support shaft is acute. The portion of the user's arm may be the user's upper arm. The acute angle between the support shaft and the platform may be in a range of about therein of about 30° to about 80°. The support shaft may have an adjustable length, allowing the user to adjust the support system to his height. In some implementations, the weight support system may also include at least one pocket or pouch for resting against the area of the waist and for receiving the anchoring member of the shooting stick. In some implementations, the support shaft may be detachable from the platform. In some implementations, the support member may have two support shaft receivers, where a first support shaft receiver is located at a first end of the platform and a second support receiver is located a second end of the platform. In such implementations, the support shaft may have a connector at a proximal end thereof that is operable to engage the first support shaft receiver and the second support shaft receiver. In such implementations, the first support shaft receiver may be positioned on the platform such that the engagement of the support shaft connector with the first support shaft receiver places the support shaft at the acute angle relative to the plane of the platform, and the second support shaft receiver may be positioned on the platform such that the engagement of the support shaft connector with the second support shaft receiver places the support shaft at an angle different from the acute angle.

In some embodiments, the present invention relates to an apparatus for supporting a person's arm that includes a cradle for receiving a portion of the person's arm, a fastening member for securing the cradle to the portion of the person's arm; and a support shaft attached to a back side of the cradle, wherein the support shaft is attached to the back side of the cradle by a articulating joint that allows the support shaft to change position relative to the cradle. The portion of the user's arm may be the user's upper arm, elbow, forearm, or wrist. The support shaft has an adjustable length to allow the user to adjust the support apparatus to his height. In some implementations, the articulating joint may be a hinge joint that allows a range of positions of about 180°. In some implementations, the apparatus may include a support shaft receiver on the back side of the cradle for engaging and holding the support shaft in a stowed position, wherein receiver is operable to reversibly engage with the support shaft. In such implementations, the receiver may be a clip, magnetic clasp, a trough, a closable compartment, or other receiving structure. In some embodiments, the support apparatus may be included in an arm support system that includes at least one pocket or pouch for resting against the area of the waist and for receiving and supporting the distal end of the support shaft. In such embodiments, the at least one pocket or pouch may be part of an apron having a plurality of pockets or pouches at various heights, allowing the user to adjust the height of the shooting stick assembly.

In some embodiments, the present invention relates to a shooting stick kit that includes a shooting stick assembly having a cradle assembly for supporting a portion of the user's arm or an object held by the user, and a support shaft connected to the underside of the cradle assembly; and at least one pocket or pouch for resting against the area of the waist and for receiving a distal end of the support shaft. In some implementations, the at least one pocket or pouch may be attached to a shoulder or waist belt. The at least one pocket or pouch may be part of an apron having a plurality of pockets or pouches at various heights, allowing the user to adjust the height of the shooting stick assembly. In some implementations, the support shaft may have an adjustable length. In some implementations, the support shaft may be connected to the cradle assembly by an articulating joint that allows the support shaft to change position relative to the cradle assembly. In some implementations, the cradle assembly may include a platform having two support shaft receivers, wherein a first support shaft receiver is located at a first end of the platform and a second support receiver is located a second end of the platform, where the support shaft has a connector at a proximal end thereof that is operable to engage the first support shaft receiver and the second support shaft receiver. In such implementations, the first support shaft receiver may be positioned on the platform such that the engagement of the support shaft connector with the first support shaft receiver places the support shaft at the acute angle relative to the plane of the platform, and the second support shaft receiver may be positioned on the platform such that the engagement of the support shaft connector with the second support shaft receiver places the support shaft at an angle different from the acute angle.

The embodiments of the present invention are discussed in more detail below.

### BRIEF DESCRIPTION OF THE DRAWINGS

FIG. 1 shows a side view of an embodiment support apparatus to an embodiment of the present invention.

FIG. 2 shows a side view of the support apparatus in use according to an embodiment of the present invention.

FIG. 3 shows a side view of a support apparatus with an extendable support shaft according to an embodiment of the present invention.

FIG. 4 shows a perspective view of a support apparatus with a support arm according to an embodiment of the present invention.

FIG. 5A shows a perspective view of a support apparatus with a platform supported by a strut according to an embodiment of the present invention.

FIG. 5B shows a side view of a support apparatus with a platform supported by a strut according to an embodiment of the present invention.

FIG. 6 shows a side, perspective view of a support apparatus with an additional extension according to an embodiment of the present invention.

FIG. 7A shows a side, perspective view of a support apparatus having a removable, adjustable cradle platform according to an embodiment of the present invention

FIG. 7B shows a side, perspective view of a support apparatus having a removable, adjustable cradle platform according to an embodiment of the present invention.

FIG. 8A shows a perspective view of a support apparatus with a collapsible hinge according to an embodiment of the present invention.

FIG. 8B shows a perspective view of a support apparatus with a collapsible hinge according to an embodiment of the present invention.

FIG. 9 shows a perspective view of a support apparatus with an elbow joint according to an embodiment of the present invention.

FIG. 10 shows a side view of a support apparatus with an additional extension according to an embodiment of the present invention.

FIG. 11 shows a side view of a support apparatus an angled additional extension according to an embodiment of the present invention.

FIG. 12A shows a side perspective view of a support apparatus having a hinged support shaft according to an embodiment of the present invention.

FIG. 12B shows a side perspective view of a support apparatus with an extendable support shaft according to an embodiment of the present invention.

### DETAILED DESCRIPTION OF THE EMBODIMENTS

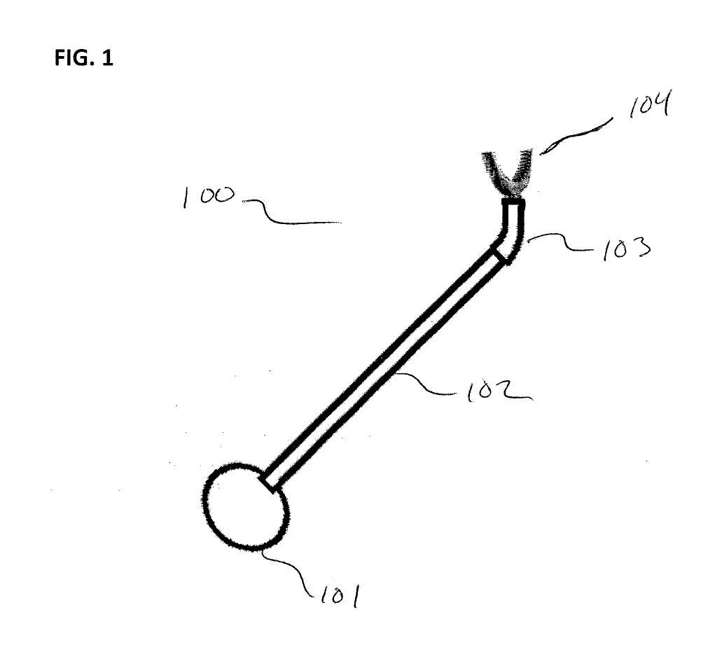

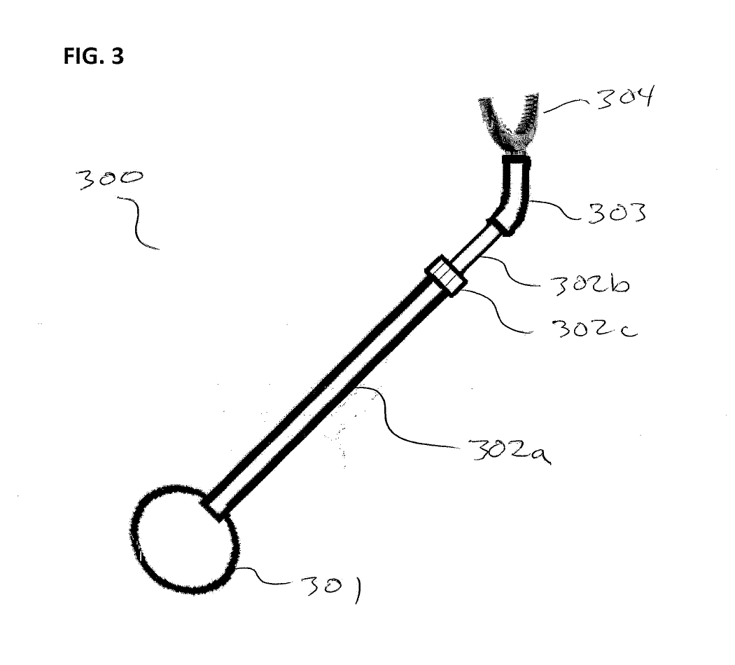

Without limiting the invention, FIG. 1 shows a shooting stick assembly 100 according to an embodiment of the present invention. The stick assembly 100 includes an anchoring member 101, a support shaft 102, an angled neck 103, and a cradle 104. The shooting stick 100 may be used to support a shooter's hand, wrist, forearm, or elbow during the act of aiming a firearm in order to hold the shooter's limb steady (see, e.g., FIG. 3 of the present application). The shooting stick assembly 100 may allow the shooter to quickly set up for a shot without having to set up a shooting stick in the ground (which is required for conventional shooting sticks, and may require adjustment of the length of the shooting stick to accommodate the terrain). The user can insert the anchoring member 101 into a pouch or pocket carried near the waist, which bears the weight of the stick assembly, the user's arm, and the item (e.g., a firearm) carried by the user. The anchoring member 101 is shown as a ball-like structure in FIG. 1. However, the anchoring member 101 may be a number of different structures, such as a foot having various shapes (e.g., cylindrical, pyramidal, rectangular prism, etc.). The shooting stick assembly 100 may be carried over one's shoulder or across one's back, and may be quickly deployed to set up a shot with support and accuracy.

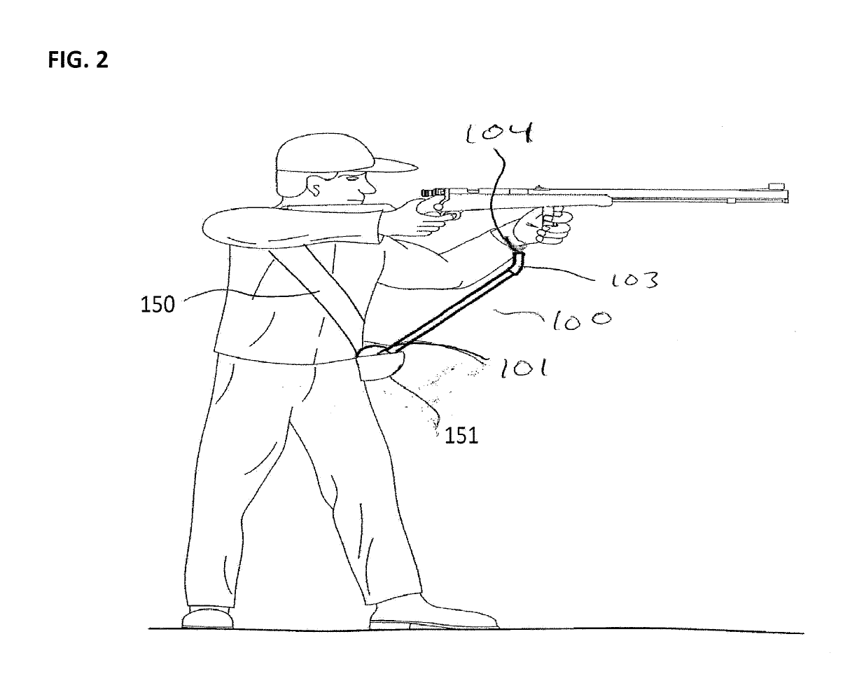

Without limiting the invention, FIG. 2 shows an example of the support apparatus (e.g., shooting stick) 100 being utilized by a hunter. The hunter is wearing a shoulder belt 150 that includes at least one pocket 151 that sits near the hunter's waist. The support apparatus assembly 100 can be quickly inserted into the pocket 151 so that the hunter's wrist may be supported by the cradle 104 during aiming and firing. The extra support may significantly improve the hunter's comfort and accuracy. The support apparatus may alternatively be supported by a pouch or pocket that is supported by a belt around the hunter's waist, as described above. In some implementations, and without limitation, an apron that includes multiple pockets or pouches may be attached to the shoulder or waist belt, providing multiple positions for the anchoring member of the shooting stick assembly. For example, and without limitation, the apron may include multiple pockets at different vertical positions in the apron, such that the user can position the anchoring member of the support apparatus assembly at different heights and thereby adjust the height of the cradle of the shooting stick. The multiple pockets allow the combination of the support apparatus assembly and the belt and apron to accommodate users having various heights, anatomies, and preferences.

The support apparatus assembly of the present invention may be further varied to increase the adjustability of the design. For example, and without limitation, the cradle 104 may be adjustable to accommodate various individuals and various positioning of the user's limb within the cradle. For example, and without limitation, the cradle may have an adjustable joint at the base of the cradle where it meets the angled neck that allows the angle between the lateral arms of the cradle to be adjusted, and/or allows the lateral arms to extended.

The elements of the shooting stick assembly may be varied in other ways as well. For example, and without limitation, the anchoring member may have various shapes and sizes. In some implementations, and without limitation, the anchoring member may have a spherical (e.g., having a diameter in the range of 1 in. to about 6 inches) or an ovoid or ellipsoid shape (e.g., having a greater diameter in the range of 1 in. to about 6 inches), or may be a foot structure with various shapes (e.g., cylindrical, pyramidal, rectangular prism, etc.), and may be made from various materials (e.g., metals, composites, polymeric materials, wood, etc.). In some implementations, and without limitation, the support apparatus may not include an anchoring member and the bottom end of the vertical support member may itself be inserted into a pouch or pocked at the waist of the user. In further implementations, and without limitation, the anchoring member may be a curved arch-like cradle structure that has a substantially complementary shape to a human waist and can rest against the curvature of the waist of the user. In such examples, there may be no need for a pouch or pocket to hold the anchoring member of the support apparatus assembly. The cradle structure may be adjustable, having an adjustable joint at the apex of the cradle where it meets the support shaft. The adjustable joint may allow the angle between the lateral arms of the cradle to be adjusted.

In some implementations, and without limitation, the angled neck may be (1) rotatable, and/or (2) operable to adjust the angle of the neck. For example, and without limitation, the cradle 104 may be attached to the angled neck by a joint that can rotate 360°. The rotatable joint may also include a locking bolt hold it in a desired orientation. The angled neck may also include a bendable section that allows the angle of the neck to be varied. For example, and without limitation, the angled neck may have a pivoting joint therein that allows the angle of the neck to be changed. The pivoting joint may include a locking mechanism (e.g., a locking bolt) to hold the angle of the neck at a desired angle during use. The operability to rotate and change the angle of the neck may allow the user to position his arm and the object held (e.g., rifle), such that the user's accuracy is optimized. The adjustment of the neck may allow the user to adjust the support apparatus such that his hand, wrist, forearm, elbow, or the rifle itself can rest in the cradle of the support apparatus assembly, depending on his preference.

Without limiting the invention, FIG. 3 shows a further variation in the support apparatus design that provides further customizability to the user. The shooting stick assembly 300 includes a telescoping, extendable support shaft 302 that includes an outer shaft 302a, an inner shaft 302b, and a locking clamp 302c (e.g., a threaded clamp, a flip-lever clamp, etc.) for arresting the position of the inner shaft 302b relative to the outer shaft 302a. The telescoping shaft 302 may allow the support apparatus assembly 300 to adjust to users of various heights and body shapes, and thereby help to provide each user with comfortable and ergonomic use of the support apparatus assembly. In further implementations, and without limitation, the extendable support shaft may include multiple telescoping joints therein to allow for more extendable length (e.g., to allow the support shaft to be extended to the ground, if the user desires).

The operability to (1) adjust the size and/or shape of the cradle, (2) to rotate and/or adjust the angle of the neck, and (3) adjust the length of the support shaft may allow the user to set the shooting stick at just the right custom orientation for the user's build and preferred shooting stance.

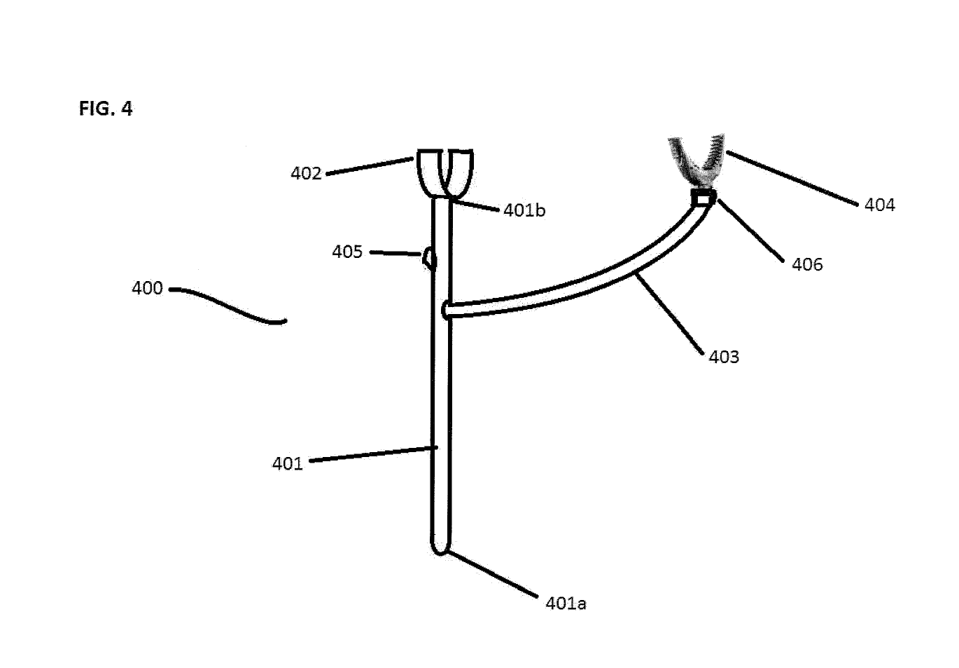

In further embodiments of the support apparatus, and without limitation, the support apparatus may include a cradle or support structure at the superior end of a vertical support member for supporting the user's upper arm or the proximal end of the firearm or other device that the user is supporting with the support apparatus. For example, and without limitation, FIG. 4 shows a support apparatus 400 that includes a vertical support member 401 having an inferior end 401a, a superior end 401b that connects with a cradle or butt support 402, a support arm 403 that projects outward from the vertical support member 401, and a cradle 404 for supporting the user's hand, wrist, forearm, or a distal portion of the firearm or other device (e.g., the forestock of a rifle) during the act of aiming a firearm in order to hold the firearm, tool, or other object steady. The cradle 404 may be connected to the support arm 403 via a rotatable joint 406 to allow the user to swivel it into a comfortable position. The bottom end of the vertical support member 401a may be positioned in a pouch or pocket of the user (e.g., in an apron as discussed above). In some implementations, and without limitation, an anchoring member may attached to the inferior end 401a of the vertical support member 401 for insertion into the pouch or pocket. The support apparatus 400 may further include a latch, clip, or other attachment means 405 on the vertical support member 401 for attachment to a shoulder belt or other anchoring point on the user. The attachment of the upper portion of the support apparatus to a shoulder belt may allow the user to steady the firearm or other object supported by the support apparatus with one hand. Additionally, and without limitation, the cradle 402 may be adjustable or replaceable to allow the shoot stick to support either the user's upper arm or the proximal end of a firearm or other object (e.g., the stock of a rifle). For example, and without limitation, the cradle 402 may have an adjustable joint at the base of the cradle where it meets the superior end of the vertical support member that allows the angle between the lateral arms of the cradle to be adjusted, such that they can be widened to comfortably receive the users upper arm or narrowed to pinch and hold steady the proximal end of the firearm or other device. In other examples, and without limitation, the support apparatus 400 may include multiple interchangeable cradles 404 that can be attached to the superior end of the vertical support member 401b: e.g., a wider cushioned cradle for supporting the user's upper arm and a narrower cradle for receiving the stock of a rifle.

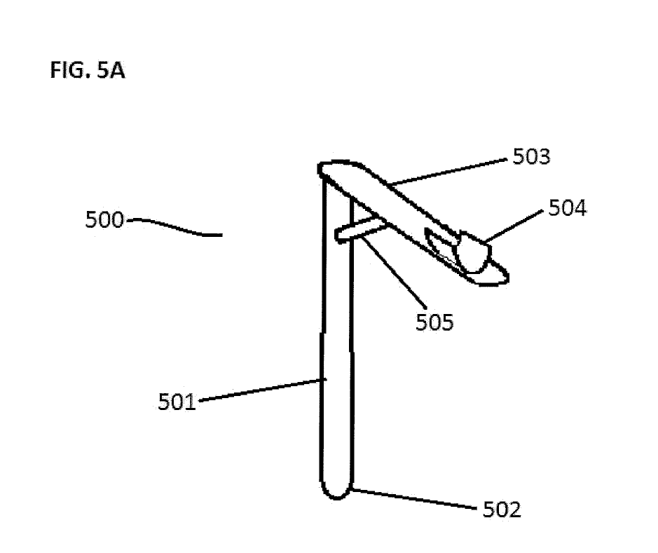

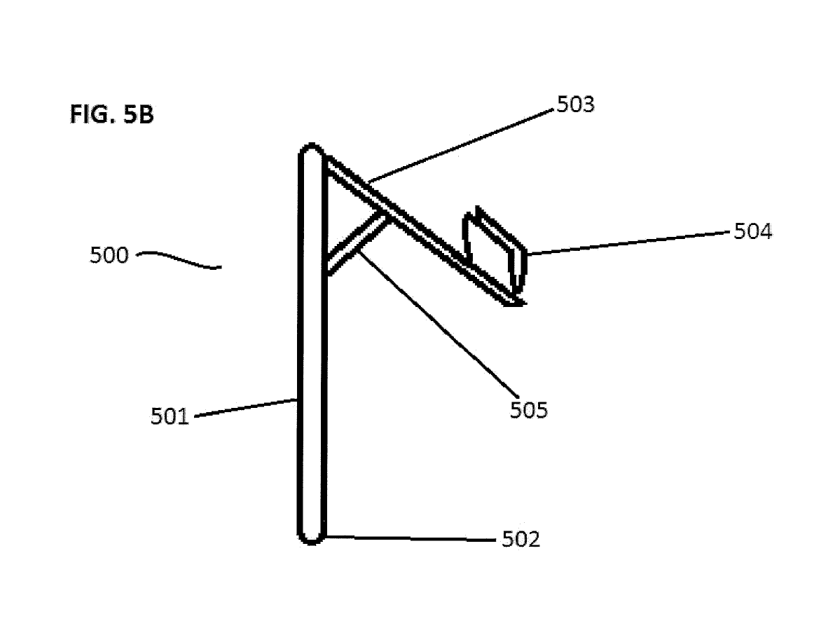

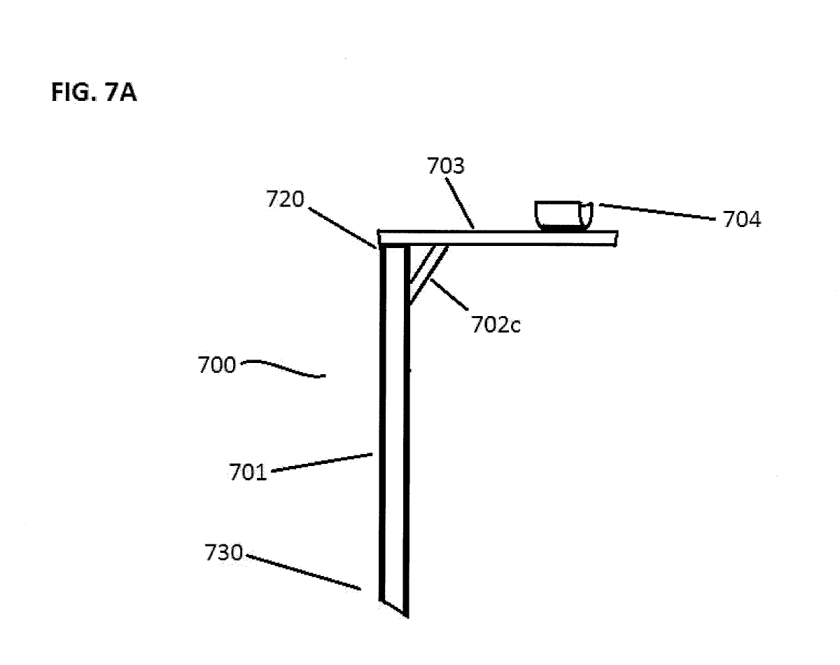

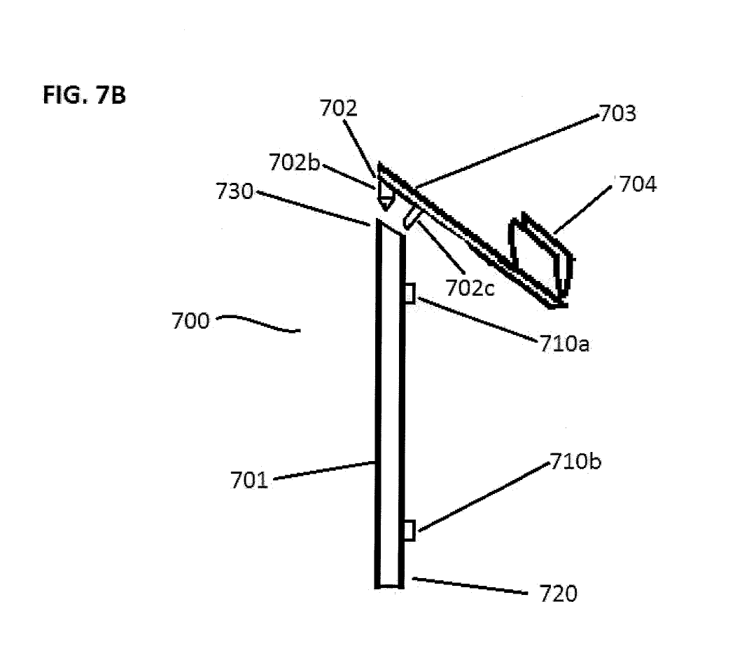

The present invention also includes embodiments of a support apparatus that supports the weight of the users arm and the object that the user is holding with a platform that includes at least one cradle thereon for receiving a portion of the user's arm. Without limiting the invention, the support structure may include a vertical support member (e.g., a leg) that may sit against or near the torso of the user (see, e.g., FIGS. 5A-11). The vertical support member may include an anchoring member on the inferior end thereof, which can be placed in a pocket or pouch positioned near the waist of the user (as shown in FIG. 2). A support platform may be attached to the vertical support member at the top of the vertical support member by a static, detachable, or hinged connection (see, e.g., FIGS. 5A-5B for an example of a static connection and FIGS. 7A-7B for examples of hinged or rotating connections).

The support apparatus may be paired with a shoulder or waist belt that includes at least one pocket that sits near the hunter's waist, as described herein. The support apparatus can be quickly inserted into the pocket so that the user's arm may be supported by a cradle on the support structure during aiming and firing. In some implementations, and without limitation, an apron that includes multiple pockets or pouches may be attached to the shoulder or waist belt, providing multiple positions for the anchoring member of the support apparatus. For example, and without limitation, the apron may include multiple pockets at different vertical positions in the apron, such that the user can position the anchoring member of the support apparatus at different heights and thereby adjust the height of the cradle of the shooting stick. The multiple pockets allow the combination of the shooting stick assembly and the belt and apron to accommodate users having various heights, anatomies, and preferences.

The vertical support member of the support apparatus may have a length designed to position the platform just under the axilla or upper portion of the user's humerus when the user's arm is extended. Variations in the user's height can be accommodated by the various pockets in the apron or other means as described below. In some embodiments, and without limitation, the vertical support member may be extendable (e.g., telescoping) such that the user may adjust the length of the support apparatus to accommodate the user's height. For example, and without limitation, the vertical support member may include a telescoping joint (e.g., like that shown in FIG. 3).

As shown in FIGS. 5A-5B, and without limitation, the platform 503 of the support apparatus may be fixedly attached to the vertical support member 501. The platform 503 may be at an acute angle relative to the vertical support member 501 in order to allow the user to rest his arm and aim a weapon (e.g., a rifle, bow and arrow, cross-bow, etc.) or other device (e.g., a telescope) comfortably. For example, and without limitation, the platform 403 may be fixed at an angle in a range of about 20° to about 89° (e.g., about 30° to about 60°, about 40° to about 50°, about 35°, or any value or other range of values therein). The platform 503 may have a cradle 504 attached to the upper surface thereof for receiving the upper arm, elbow, or forearm of the user. The cradle 504 may be padded and provide comfortable support to the user. The platform may have a length that provides support to users having arms of various lengths, and the cradle maybe slidably mounted on the platform such that the position of the cradle 504 can be adjusted to accommodate the arm length of the user. The cradle may include a locking pin or bolt that allows the user to arrest the cradle 504 on the slidable mount in a desired position.

The platform may be supported by a strut 505 that connects to the bottom surface of the platform 503 and to the vertical support 501 at a point that is inferior to the connection between the vertical support 501 and the platform 503. The strut 504 functions to aid in supporting the position of the platform 503 under the load of the user's arm.

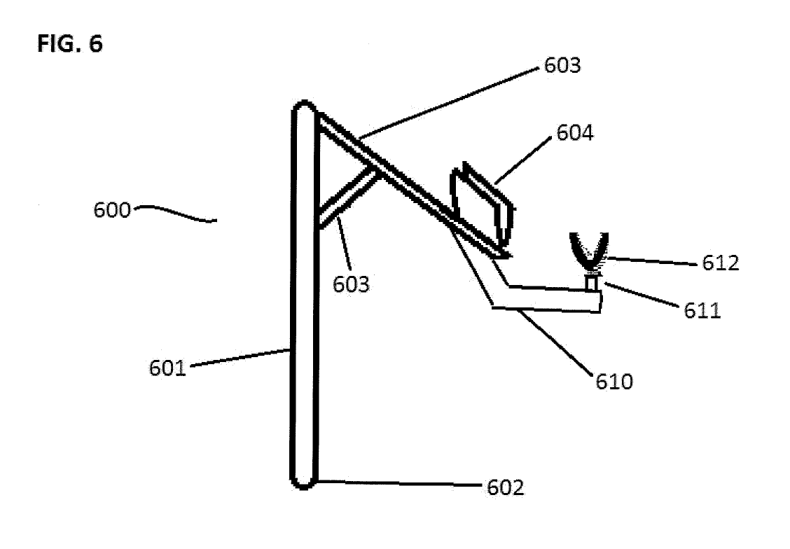

In further implementations, and without limitation, the support apparatus may include an additional wrist support structure to provide the user with further support and steadiness. FIG. 6 shows a support apparatus 600 that is similar to the support apparatus 500, but includes an additional assembly for supporting the user's wrist that includes an extension arm 610, an adjustable joint 611, and a wrist cradle 612. The adjustable joint 611 may be rotatable and/or vertically extendable to allow the user to swivel and vertically adjust the cradle to his comfort. In further implementations, and without limitation, the length of the extension arm may be adjustable (e.g., telescopic) to allow the user to extend or retract the extension arm to his comfort.

In some embodiments, and without limitation, the platform may be detachable form the vertical support member and the vertical support member may be configured such that each end of the vertical support member may connect to the platform (see, e.g., FIGS. 7A-7B). For example, and without limitation, the vertical support member 701 may have (1) a first end 720 that has an orthogonal surface that creates an orthogonal connection between the vertical support member 701 and a platform 703 configured to be positioned about horizontally during use, and (2) a second end 730 that has a slanted surface that creates a slanted connection between the vertical support member 701 and the platform 703 that is configured to be positioned at a downward slope during use. The ends 720 and 730 may connect with the platform 703 by a connection assembly 702 that includes a rotatable pin 702b and a rotatable strut 702c. Both the rotatable pin 702b and the rotatable strut 702c may be connected to the underside of the platform 703 by hinge joints that allow the angular positions of the pin 702b and the strut 702c relative to the platform 703 to be adjusted. The adjustable positions of the pin 702b and strut 702c allow the pin and the strut to engage either end 720 or 730 of the support member 701. For example, the pin 702b may be positioned at an orthogonal position relative to the platform 703 in order to be inserted and engage with a receiver (e.g., a hole) in end 720 of the support member 701 and strut 702c may be rotated to meet strut receiver 710b once pin 702b is engaged with end 720 (see, e.g., FIG. 7A). Also, the pin 702b may be positioned at an acute angle relative to the platform 703 for insertion into a receiver (e.g., a hole) in end 730 and the strut 702c may be rotated to meet strut receiver 710a once pin 702b is engaged with end 730 (see, e.g., FIG. 7B). It is to be understood that the scope of the present invention includes other connection mechanism for engaging support member 701 with the platform 703.

As shown in FIG. 7A, the orthogonal end 720 of the vertical support member creates an about right angle connection between the vertical support member 701 and the platform 703. As shown in FIG. 7B, the slanted end 730 of the vertical support member creates an oblique angle connection between the vertical support member 701 and the second platform 703. The configuration of the support apparatus shown in FIG. 7A (about horizontal) provides support that the user may find appropriate for bow hunting, using a telescope, and various other applications. The configuration of the support apparatus shown in FIG. 7B (sloped downward) provides support that the user may find appropriate for using a rifle and various other applications.

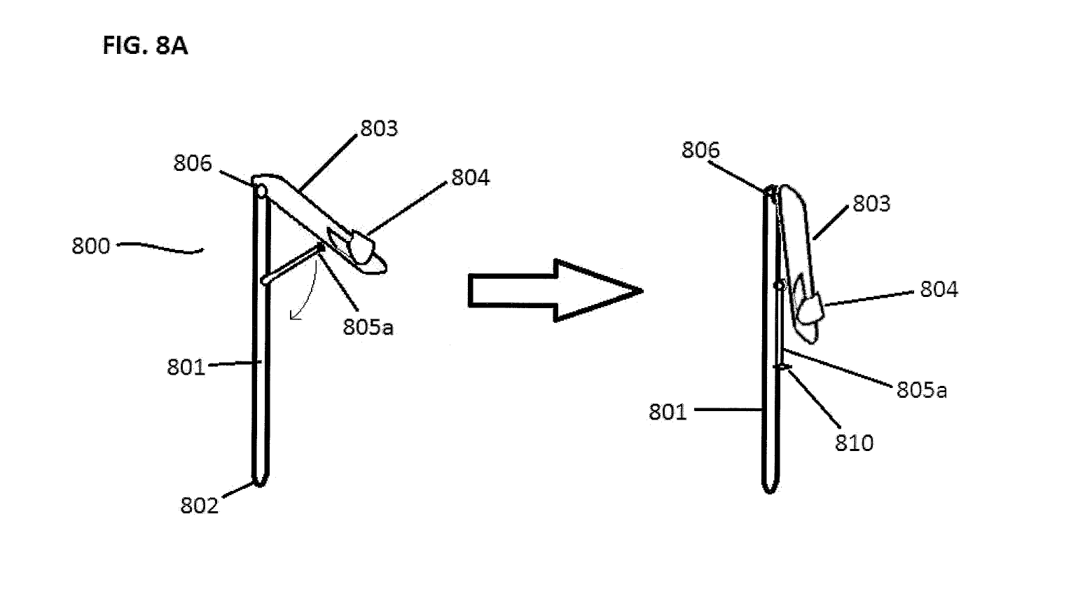

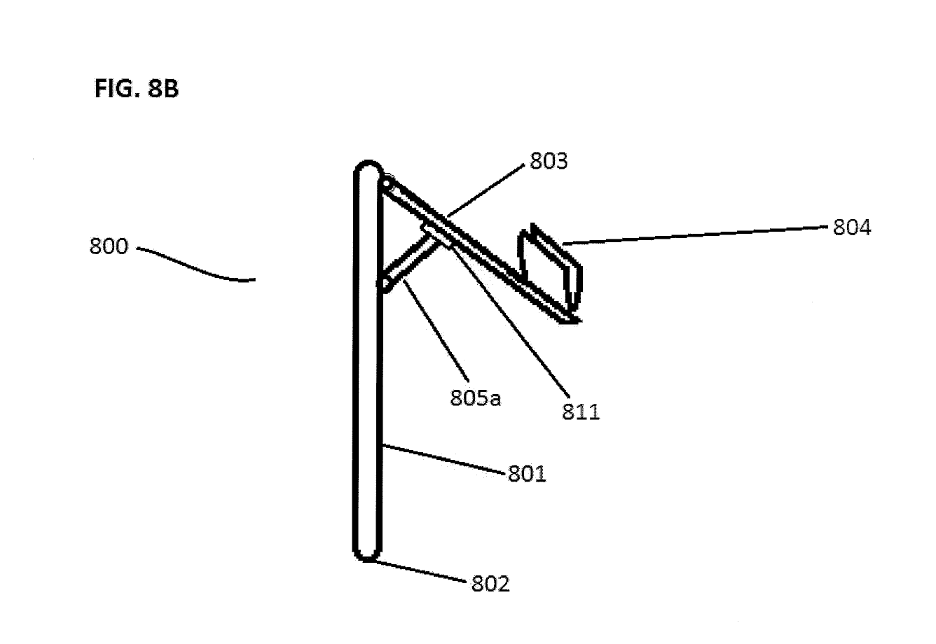

In related embodiments, and without limitation, the platform may be adjustably connected to the vertical support . For example, and without limitation, the support apparatus 800 shown in FIGS. 8A-8B may include a platform 803 that is hingedly attached to the vertical support member 801 by a hinge joint 806. The support apparatus 800 may also include a rotatable strut 805a that is hingedly or rotatably connected to the vertical support member 801, and connects with the inferior side of the platform 803 to support the weight of the platform during use. The rotatable strut may include an engagement surface 810 for engaging the bottom of the platform 803. Additionally, the platform 803 may include a receiver 811 on the inferior side thereof for receiving the engagement surface 810 of the rotatable strut 805a. In some implementations, and without limitation, the receiver 811 may have one or more receiving slots therein that each have a complementary shape to the engagement surface 810 of the rotatable strut 805a. In still further implementations, and without limitation, the rotatable strut may include a telescoping joint that allows the user to adjust the length of the prop rod to accommodate the user's preferred angle of support.

As shown in FIG. 8A, the support apparatus 800 may be collapsed during non-use by disengaging a rotatable strut 805a from the platform 803 and can then be carried on the shoulder belt (e.g., it may be clipped or tied to the shoulder belt). The support apparatus 800 can also be quickly deployed by inserting the anchoring member 802 in a pocket or pouch on the shoulder belt, raising the platform 803, and positioning the rotatable strut 805a under the platform 803.

In further embodiments, and without limitation, the rotatable strut may be hingedly attached to the bottom of the platform, instead of the vertical support member. In such embodiments, and without limitation, the vertical support member may include one or more slots, holes, or other receivers into which the rotatable strut may be inserted. In embodiments in which the vertical support member includes a plurality of receivers for receiving the rotatable strut, the angle of the platform can be adjusted to the user's preference by changing the slot into which the rotatable strut is inserted.

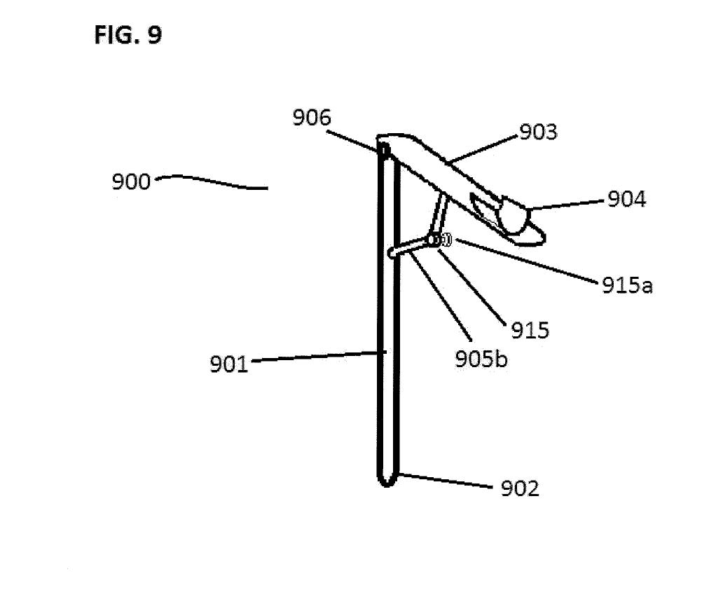

FIG. 9 shows a support apparatus 900 having an adjustable connection between the platform 903 and the vertical support member 901. In such embodiments, and without limitation, the platform 903 may be rotatably connected to the vertical support member 901 by a joint 906, and the weight placed on the platform 903 may be supported by a collapsible arm 905b that includes a rotatable and lockable elbow joint 915. The elbow joint 915 may include a locking bolt or pin 915a that allows the user to adjust the platform to the desired angle relative to the vertical support member 901 and then lock the platform 903 into the desired position by arresting the elbow joint 905b. The support apparatus 900 can be easily collapsed by disengaging the locking pin or nut 915a from the elbow joint 915 and collapsing the collapsible arm 905b.

In some implementations and without limitation, the vertical support member may have an adjustable height by its insertion into one of a plurality of pockets in an apron worn on or near the waist of the user, as described herein. The apron may have multiple pockets at different vertical locations on the apron, such that the anchoring member can be placed at different vertical positions by virtue of the pocket into which it is inserted. The adjustability of the vertical position of the vertical support member may allow the user to accommodate for his height and build, and optimize the comfortable use of the support apparatus.

In other implementations, and without limitation, the vertical support member may have an adjustable length for accommodating the height and build of the user and to optionally allow the user to extend the vertical support member for positioning on the ground. For example, and without limitation, the vertical support member may include a telescoping rod therein with sufficient length to extend the vertical support member 401 from the axilla of the user to flat or sloped ground on which the user is standing.

In some embodiments, and without limitation, the support apparatus may include an additional cradle structure that extends from the end of the platform that can be used to support the user's wrist or forearm, the forestock of a rifle, the barrel of a pistol, the distal end of a telescope or other structures. The additional (distal) cradle structure may include an adjustable rod (e.g., a telescoping or sliding rod, etc.) that can extend several inches (e.g., about 3 inches to about 24 inches) beyond the end of the platform, and may include a cradle structure on a distal end thereof. The adjustable rod may additionally have a joint therein that allows vertical rotation of all or a portion of the rod to adjust a height of the cradle relative to the platform. The adjustability of both the length of the rod and the height of the cradle may allow the user to optimize the position of the cradle for comfortable use.

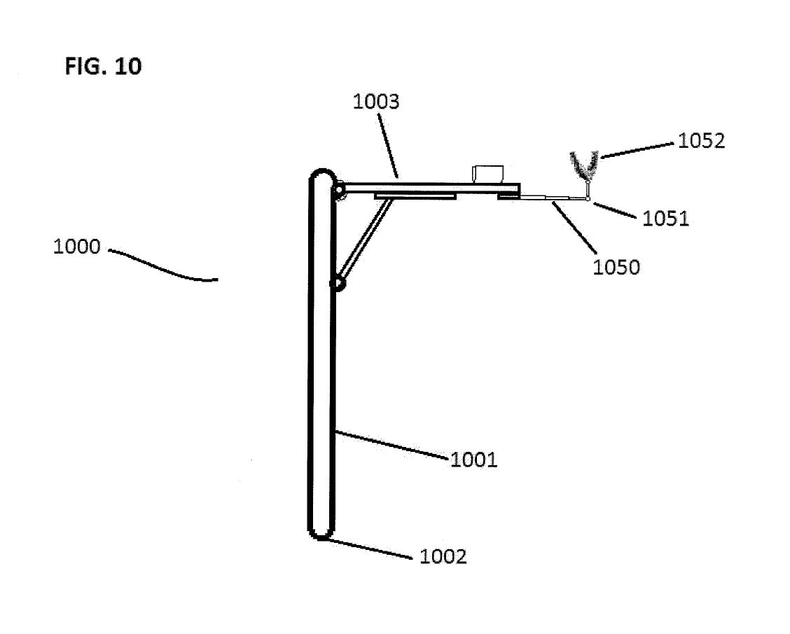

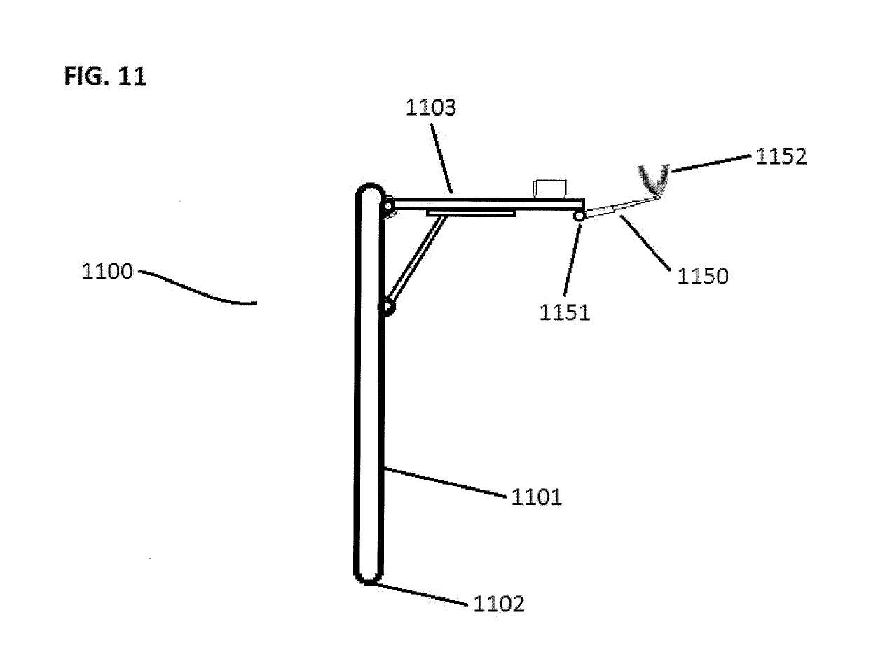

As examples, and without limitation, FIGS. 10-11 show support apparatus 1000 and 1100, respectively, which each include an additional distal cradle for supporting a user's wrist or forearm, a forestock of a rifle, a barrel of a pistol, a distal end of a telescope or other structures. In FIG. 10, support apparatus 1000 includes a telescoping rod 1050 that is extendable from the bottom side of the platform 1003. The distal section of the rod 1050 may include a rotatable joint 1051 therein that allows the distal section of the rod and a cradle 1052 thereon to be raised relative to the platform into a position that provides comfortable support to the user. The rotatable joint 1051 may be lockable (e.g., with a locking bolt or pin) to allow the user to maintain the position of the cradle 1052 in a preferred position. The cradle 1052 may be connected to the rod 1050 by a rotatable joint as well, such that the cradle 1052 may oriented in a vertical position.

A support apparatus 1100 is shown in FIG. 11, which may include a rotating joint 1151 that connects a telescoping rod 1150 to the platform 1103. The joint 1151 may be rotatable along a vertical plane to allow the user to adjust a height of a cradle 1152 attached to the distal end of the rod 1150 relative to the platform 1103. The rotatable joint 1151 may also be lockable (e.g., with a locking bolt or pin) to allow the user to maintain the position of the cradle 1152 in a preferred position. The cradle 1152 may be connected to the rod 1150 by a rotatable and lockable joint as well, such that the cradle 1152 may oriented in a vertical position. In the implementation shown in FIG. 11, the cradle 1152 and rod 1150 may be stored under the platform when not in use by collapsing the telescoping rod 1150 and rotating the rod 1150 under the platform 1103. The cradle can also be rotated such that it sits closely to the bottom of the platform. It is to be understood that the scope of the present invention is not limited to such implementations, and that other forms of the extendable cradle are contemplated within the scope of the present description.

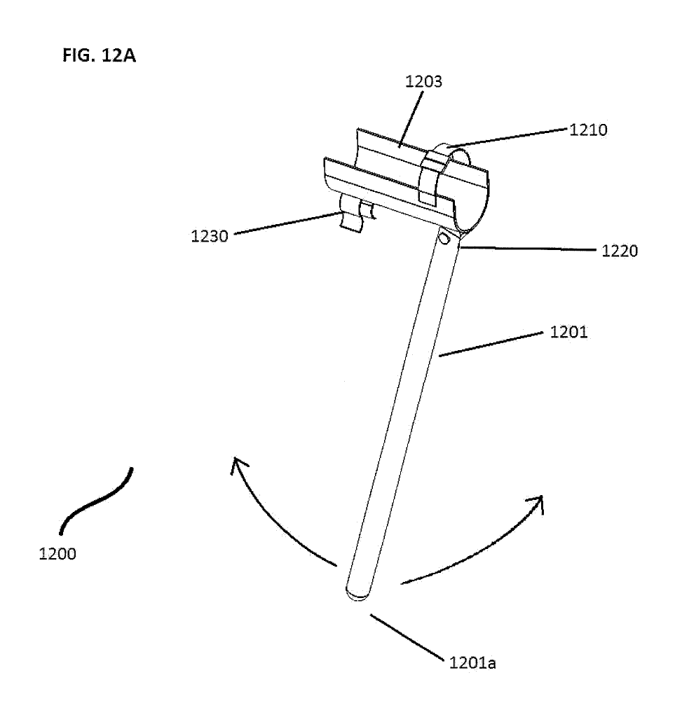

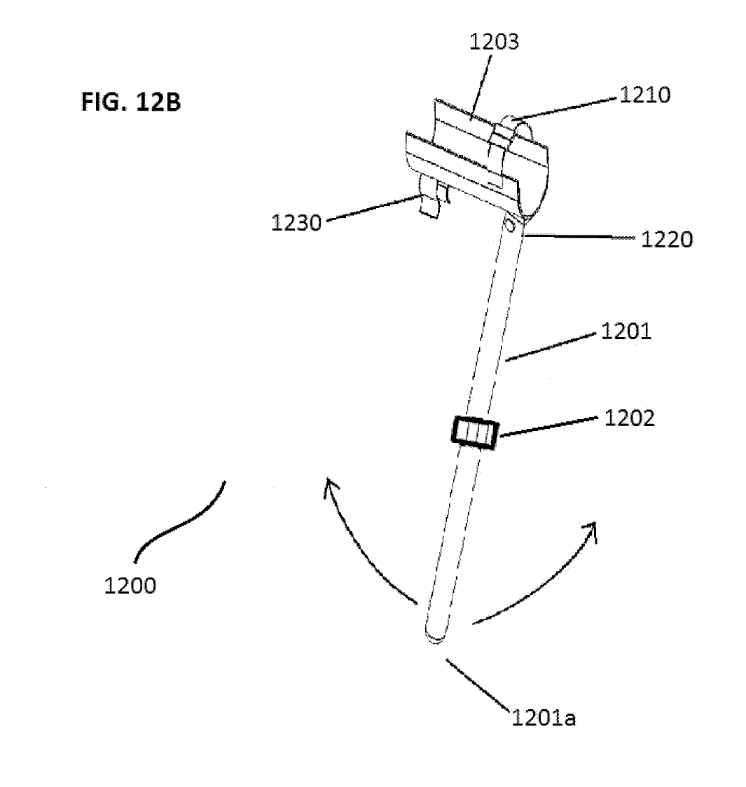

FIGS. 12A-12B show further embodiments, of the present invention in which the cradle 1203 may be strapped to the user's arm (e.g., the upper arm) by an adjustable strap 1210. The adjustable strap 1210 may have an adjustable length and a clasp or clip that allows the user to quickly fasten the strap over his arm and quickly release the strap. It is to be understood that the support apparatuses shown in FIGS. 12A-12B may have further or alternative fastening for attaching to the user's arm. For example, the support apparatus may include multiple straps or belts, a cuff, etc. A support member or leg 1201 may be rotatably attached to the bottom side of the cradle by a rotating joint 1220 such that it can be positioned at various angles with respect to the cradle 1203 along a single plane that passes through the length of the cradle 1203. The support member 1201 may be swung into a roughly vertical position and its distal end 1103a may be inserted into a pocket on the user's shoulder belt (or waist belt) as described herein, to thereby support the weight of the user's arm during use. The weight support apparatus 1200, may also include a receiver for the support member 1201 that is operable to hold the support member 1201 in a stowed position against the cradle 1203. In some implementations, the receiver may be a storage clip 1230 that receives the support member 1201 during non-use of the weight support device 1200. The support member 1201 can be swung toward the clip 1230 and snap-fit into position in the clip 1230. The clip 1230 may hold the support member 1201 in the stowed position against the cradle 1203, until the user pulls the support member 1201 out of the clip for use. In other implementations, the receiver structure for the support shaft may be a a magnet, a trough, closable compartment, or other structure for holding the support shaft in the stowed position.

The embodiments shown in FIGS. 12A-12B provide a convenient, easily deployed weight support device that may be stowed on the user's person without any obstruction of the user's movement. In some implementations, and without limitation, the support member may be a telescoping rod having two or more nested segments that can be locked into position with respect to one another (e.g., with locking collars). As shown in FIG. 12B, the support shaft 1201 may be an extendable telescoping structure that allows the user to adjust the length of the support shaft to best fit the user's height and anatomy, and the support member may be collapsed when it is stored such that its length may not extend above the user's shoulder. The support shaft shown in FIG. 12B includes an outer shaft, an inner shaft, and a locking clamp 1202 (e.g., a threaded clamp, a flip-lever clamp, etc.) for arresting the position of the inner shaft relative to the outer shaft. The telescoping shaft 1202 may allow the support apparatus assembly 1200 to adjust to users of various heights and body shapes, and thereby help to provide each user with comfortable and ergonomic use of the support apparatus assembly. In further implementations, and without limitation, the extendable support shaft may include multiple telescoping joints therein to allow for more extendable length (e.g., to allow the support shaft to be extended to the ground, if the user desires).

In some implementations, and without limitation, the hinge joint 1220 may be connected to the underside of the cradle 1203 by a swivel joint, such that not only can the support shaft is swing due to the pivoting action of the hinge joint, the hinge joint 1220 itself can swivel to change the angle of the plane along which the support shaft swings. The swiveling action of the hinge joint may allow the user to adjust the support apparatus such that the user can comfortably support his arm in positions that are further away from the midline of the user's body (e.g., positions lateral to the user's shoulder girdle).

The present invention provides a weight support device for a person supporting an elongate object at generally horizontal pitch. Specific uses of the invention include use as a shooting stick for firearms. It is to be understood that here are several variations in the weight support device that provide additional benefits, as disclosed above. It also to be understood that the present invention is not limited to firearms and that the present invention may be used to support a person's arm when using various other elongate devices, such as telescopes, bow and arrow, cross-bows, etc.

It should further be understood that the foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed:

1. A weight support system, comprising:
a. an anchoring member for resting against a user's body in the area of the waist;
b. a support member including a platform and a cradle for supporting a portion of the user's arm or an object held by the user; and
c. a support shaft extending from the anchoring member to the support member, wherein an angle between the plane of the platform and the support shaft is acute.

2. The system of claim 1, wherein said portion of the user's arm is the user's upper arm.

3. The system of claim 1, further comprising at least one pocket or pouch for resting against the area of the waist and for receiving the anchoring member of the shooting stick.

4. The system of claim 1, wherein support shaft is detachable from said platform.

5. The system of claim 5, wherein said support member has two support shaft receivers, wherein a first support shaft receiver is located at a first end of said platform and a second support receiver is located a second end of said platform, wherein said support shaft has a connector at a proximal end thereof that is operable to engage said first support shaft receiver and said second support shaft receiver.

6. The system of claim 6, wherein said first support shaft receiver is positioned on said platform such that the engagement of said support shaft connector with said first support shaft receiver places said support shaft at said acute angle relative to said plane of said platform, wherein said second support shaft receiver is positioned on said platform such that the engagement of said support shaft connector with said second support shaft receiver places said support shaft at an angle different from said acute angle.

7. The system of claim 1, wherein the acute angle between the support shaft and the platform is in a range of about therein of about 30° to about 80°.

8. The system of claim 1, wherein the support shaft has an adjustable length.

9. An apparatus for supporting a person's arm, comprising:
a. a cradle for receiving a portion of said person's arm,
b. a fastening member for securing said cradle to said portion of said person's arm; and
c. a support shaft attached to a back side of said cradle, wherein said support shaft is attached to said back side of said cradle by a articulating joint that allows said support shaft to change position relative to said cradle.

9. The apparatus of claim 9, wherein said portion of the user's arm is the user's upper arm, elbow, forearm, or wrist.

11. The apparatus of claim 9, wherein the support shaft has an adjustable length.

12. The apparatus of claim 9, wherein said articulating joint is a hinge joint that allows a range of positions of about 180°.

13. The apparatus of claim 9, further comprising a support shaft receiver on said back side of said cradle for engaging and holding said support shaft in a stowed position, wherein receiver is operable to reversibly engage with said support shaft.

14. A an arm support system comprising:
a. apparatus of claim 9; and
b. at least one pocket or pouch for resting against the area of the waist and for receiving and supporting the distal end of said support shaft.

15. A shooting stick kit, comprising:
a. a shooting stick assembly comprising:
i. a cradle assembly for supporting a portion of the user's arm or an object held by the user, and
ii. a support shaft connected to the underside of said cradle assembly; and
b. at least one pocket or pouch for resting against the area of the waist and for receiving a distal end of said support shaft.

16. The kit of claim 15, wherein said at least one pocket or pouch is attached to a shoulder or waist belt.

17. The kit of claim 15, wherein said at least one pocket or pouch is part of an apron having a plurality of pockets or pouches at various heights, allowing the user to adjust the height of the shooting stick assembly.

18. The kit of claim 15, wherein the support shaft has an adjustable length.

19. The kit of claim 15, wherein said support shaft is connected to said cradle assembly by an articulating joint that allows said support shaft to change position relative to said cradle assembly.

20. The kit of claim 15, wherein said cradle assembly includes a platform having two support shaft receivers, wherein a first support shaft receiver is located at a first end of said platform and a second support receiver is located a second end of said platform, wherein said support shaft has a connector at a proximal end thereof that is operable to engage said first support shaft receiver and said second support shaft receiver,
wherein said first support shaft receiver is positioned on said platform such that the engagement of said support shaft connector with said first support shaft receiver places said support shaft at said acute angle relative to said plane of said platform, wherein said second support shaft receiver is positioned on said platform such that the engagement of said support shaft connector with said second support shaft receiver places said support shaft at an angle different from said acute angle.
